(19) United States
(12) Patent Application Publication
(10) Pub. No.: US 2007/0069657 A1
(43) Pub. Date: Mar. 29, 2007

(54) Elevator lights

(75) Inventors: Michael Earl Tuttle, Los Alamitos, CA (US); Walter Parsley Barnes, Meritt Island, FL (US)

Correspondence Address: LOWE HAUPTMAN BERNER, LLP, 1700 DIAGONAL ROAD, SUITE 300, ALEXANDRIA, VA, 22314, US

(73) Assignee: Electronic Controls, Inc., Cape Canaveral, FL (US)

(21) Appl. No.: 11/232,985

(22) Filed: Sep. 23, 2005

(51) Int. Cl. H05B 37/02

(52) U.S. Cl. 315/159

(57) ABSTRACT

An elevator cab includes primary and auxiliary light sources. A light sensor responsive to light from the primary light source causes activation of the auxiliary light source when the primary light source fails. The light sources are inside the cab for passenger use and/or outside the cab for maintenance worker use. A battery for auxiliary light is selectively charged by first and second current levels in response to the battery voltage being above or below first or second different thresholds.

### FIELD

The disclosed embodiments relate to an auxiliary elevator cab illumination arrangement and method.

### BACKGROUND

Light fixture 108 (FIG. 1) mounted inside an elevator cab provide primary illumination to the interior of the cab. In certain circumstances, primary light fixture 108 may become disabled through either natural occurrences, e.g., corrosion, wire breakage, earthquake, tornado, fire, flood, power outage, etc., or as a result of a person, e.g., vandalism, accidental breakage, etc. With primary light fixture 108 disabled, the interior of cab 100 receives no illumination, thereby preventing or impeding the ability of elevator passengers to view and/or manipulate control panel 106. Additionally, elevator passengers may feel frightened due to being confined in a dark space.

### SUMMARY

The present embodiments provide an elevator illumination arrangement and method.

An auxiliary elevator illumination arrangement includes a visible light source, an optical sensor for transmitting a light loss signal responsive to detection of visible light below a predetermined visible light threshold, a power connection for supplying power to the light source, and a power switch connectable with the power connection and the light source. The power switch enables the power connection to power the light source in response to receipt by the power switch of the light loss signal from the light sensor.

A method embodiment includes monitoring a light level provided by a primary light source of an elevator cab and activating an auxiliary elevator light source of the elevator cab in response to detection of the monitored light level falling below a predetermined threshold.

Still other advantages of the embodiments will become readily apparent to those skilled in the art from the following detailed description, wherein the preferred embodiments are shown and described, simply by way of illustration of the best mode contemplated of carrying out the invention. As will be realized, the invention is capable of other and different embodiments, and its several details are capable of modifications in various obvious respects, all without departing from the embodiments.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, which has been briefly discussed, is a perspective interior view of an elevator cab including an embodiment;

FIG. 2 is a block diagram of one embodiment of equipment included in FIG. 1;

FIG. 3 is a block diagram of another embodiment of equipment included in FIG. 1;

FIG. 4 is a block diagram of the charging unit of the FIG. 3 embodiment;

FIG. 5 is a block diagram of another embodiment of equipment included in FIG. 1;

FIG. 6 is a block diagram of an additional embodiment of equipment included in FIG. 1;

FIG. 7 is a perspective exterior view of an elevator cab top including an embodiment; and

FIG. 8 is a perspective exterior view of an elevator cab bottom including an embodiment.

### DETAILED DESCRIPTION OF THE PREFERRED EMBODIMENTS

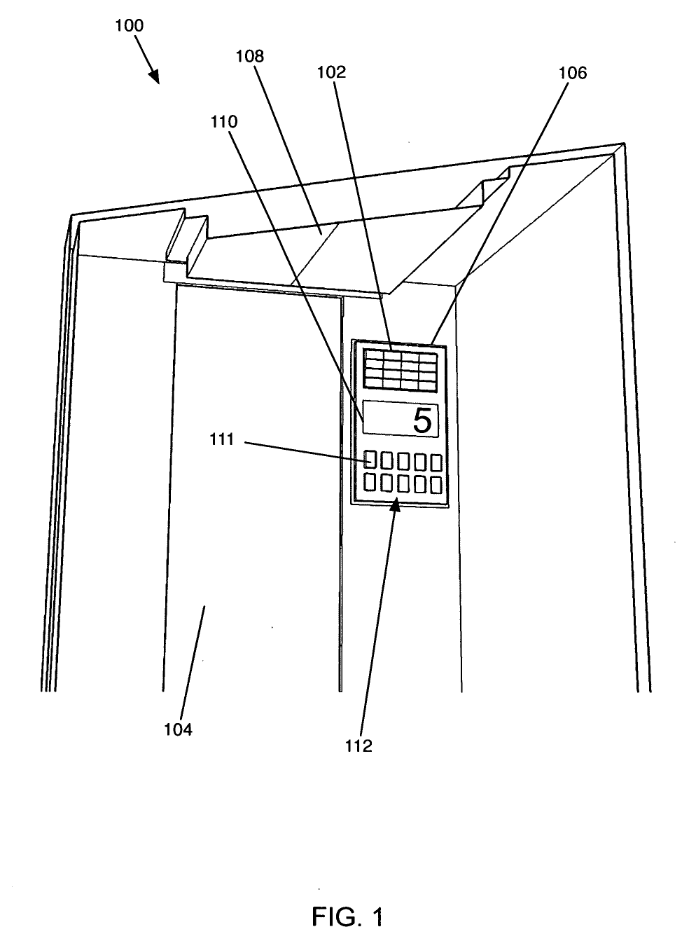

FIG. 1 is an illustration of an interior view of an elevator cab 100 having an auxiliary light fixture 102. Cab 100 includes a door opening 104 permitting ingress/egress of elevator passengers to the interior of the cab, a control panel 106 enabling control of the elevator functionality, and a primary light fixture 108 including a light source (not shown) for providing interior illumination of the cab during normal operation of the primary light fixture. In operation, auxiliary light fixture 102 illuminates the interior of cab 100 in the event of primary light fixture 108 failing to provide interior illumination, e.g., due to fixture 108 not being powered or being broken, vandalized, etc.

In another embodiment, auxiliary light fixture 102 provides illumination in response to lack of power and/or lack of illumination in the interior of cab 100.

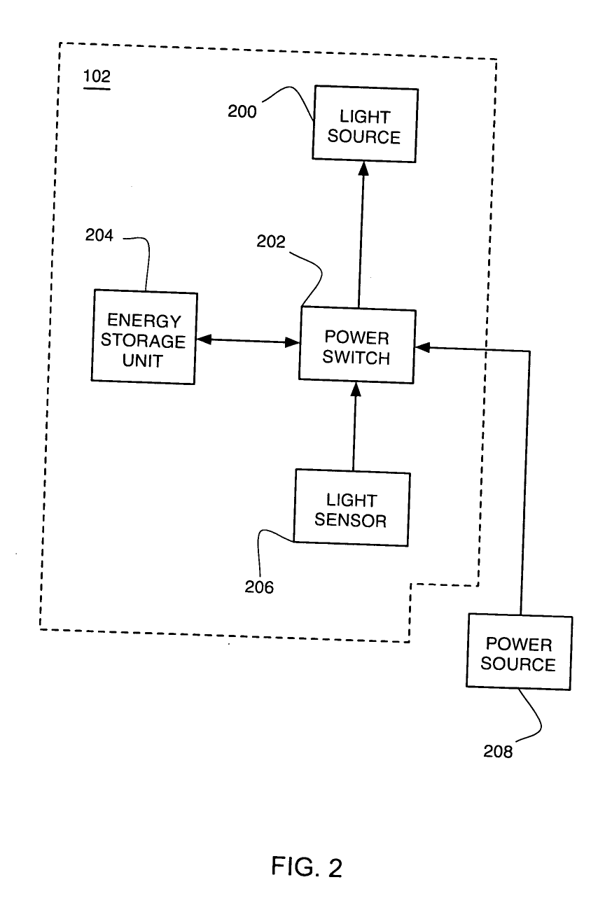

Although FIG. 1 is an illustration of an embodiment in which auxiliary light fixture 102 is part of control panel 106, in other embodiments, auxiliary light fixture 102 is positioned separate from the control panel, e.g., located on the ceiling or separated into component parts (described below in conjunction with FIGS. 2, 3, and 5) located in multiple locations.

Cab 100 is generally a closed rectangular box, i.e., a right parallelepiped, having no windows for receiving exterior light to the interior. Due to the lack of exterior light, the primary light fixture 102 illuminates the interior of the cab, thereby enabling a passenger of the elevator cab to view and manipulate control panel 106. Control panel 106 includes auxiliary light fixture 102, display 110, and a control arrangement 112. An elevator passenger views elevator status information displayed on display 110 and manipulates controls 112 to cause the elevator cab to move to a desired location, e.g., to move to a particular floor at which the passenger desires to exit the elevator cab 100.

Although not depicted in FIG. 1, elevator cab 100 receives power and communicates with a controller (not shown) via cabling and communication links, either wired or wireless. For example, an elevator passenger pressing one of control buttons 111 causes a signal to be transmitted to the controller indicating the passenger's request. The controller then causes activation of additional elements not relevant to the present embodiments to cause movement of elevator cab 100.

Auxiliary light fixture 102 is now described in detail with respect to FIG. 2. Fixture 102 includes a light source 200, e.g., one or more light-emitting diodes or some other low power-consuming, light-producing source. Light source 200 is a low power-consuming light source to minimize power requirements and maximize the amount of illumination time when operating under battery power. If primary source 108 fails, light source 200 provides illumination to the interior of cab 100 to enable elevator passengers to see control panel 106 and to soothe the passengers of cab 100. In an embodiment, light source 200 comprises 24 light emitting diodes (LEDs) arranged in six groups of four LEDs. Each LED produces white light at 18,000 millicandles over a thirty degree beam width generating an illumination level of 19 lux. The exemplary LEDs each draw 20 mA of current resulting in a combined 480 mA draw at 4.8 volts.

An embodiment of auxiliary light fixture 102 exceeds Federal, State, and City codes for elevator cab interior emergency lighting requirements, e.g., American Society of Mechanical Engineers (ASME) A17.1, Rule 204.7. In an embodiment, auxiliary light fixture 102 produces 25 times the emergency lighting candle power required under the Rule, and the light intensity produced is maintained for a minimum of 6 hours (exceeding by 50% the time required under the Rule). In still another embodiment, fixture 102 provides, from an elevator cab ceiling height of eight feet, 5 foot-candles illumination on the floor beneath opening 104 (where the door threshold is located) and control panel 106. Such emergency illumination provided by fixture 102 enables trapped or ill-lighted passengers to view control panel 106 so they can manipulate emergency call buttons, alarms, phone, etc., and, if necessary, have lighted egress from elevator cab 100.

Fixture 102 further includes a normally open power switch 202 connected to light source 200, an energy storage unit 204, a light sensor 206, and a power source 208. Power switch 202 controls the flow of current to light source 200 under control of light sensor 206. Energy storage unit 204 includes a storage cell for storing electric energy until needed at a later time, e.g., a battery such as a Nickel-Metal Hydride, Nickel-Cadmium, Lithium-Ion, or other battery types. In an exemplary embodiment, energy storage unit 204 comprises four series-connected NiMH batteries each capable of providing 1.2 Volts at 480 mA. Power source 208 typically is an available alternating current (AC) commercial power source such as provided to the elevator system. Unit 204 includes a suitable rectifier circuit for converting the AC of source 208 into direct current (DC) charging current for the battery.

Light sensor 206 detects the light level in the interior of cab 100 and transmits a signal indicative of the detected light level to power switch 202. In an embodiment, light sensor 206 is a photoconductive cell such as an NSL-4542 available from Silonex Inc. of Quebec, Canada. Light sensor 206 is positioned in the interior of cab 100 at a location where the sensor is responsive to the presence and absence of light from primary light source 108, but is not responsive to the emission of light from auxiliary light source 102.

Hence, light sensor 206 is positioned and/or mounted in a way such that, in the event of primary light source 108 becoming disabled, the light sensor does not detect enough illumination provided by light source 200 to cause power switch 202 to disable power flow to light source 200. For example, light sensor 206 is positioned at an upper portion of cab 100 near and/or facing primary light source 108. Additionally, light sensor 206 is shrouded so it does not directly receive illumination from auxiliary light source 102.

Power switch 202 compares the detected light level as indicated by the received light sensor 206 signal to a predetermined light threshold value. If the light level detected by sensor 206 exceeds the light threshold value, contacts of power switch 202 remain open to prevent the flow of current to light source 200. However, if the detected light level fails to exceed the light threshold value, the contacts of power switch 202 close to allow the flow of current to light source 200.

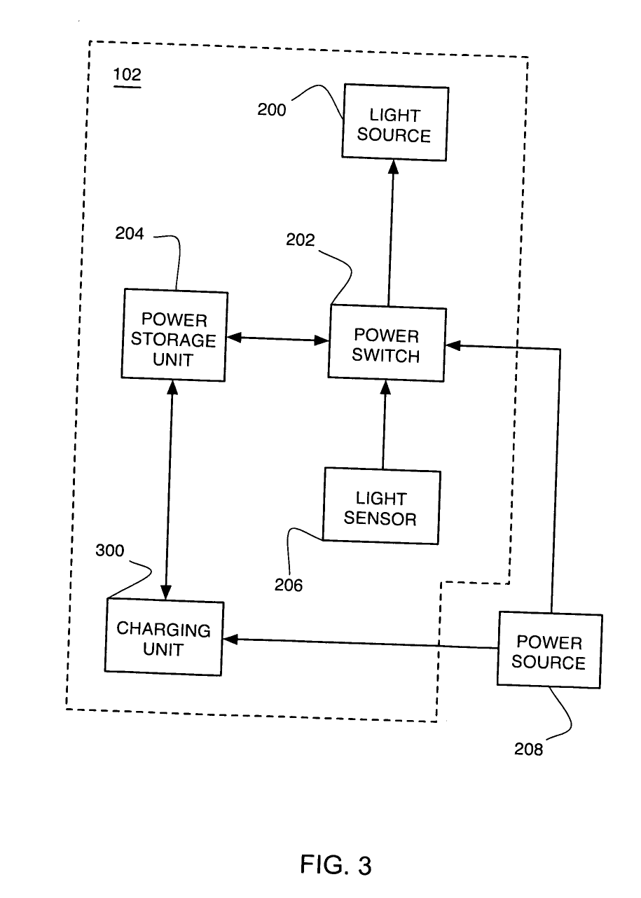

Power switch 202 couples current to light source 200 from either energy storage unit 204 or power source 208. Current from power source 208 has priority over current from energy storage unit 204 to ensure that the energy storage unit remains at peak capacity until needed. In the event of loss of power from power source 208, power switch 202 supplies current from energy storage unit 204 to light source 200. Charging and maintenance of energy storage unit 204 are described below in conjunction with FIG. 3.

The above-described auxiliary light fixture 102 provides illumination to the interior of cab 100 in the event of the detection of loss of light from primary light source 108 in the cab. Additionally, auxiliary light fixture 102 is able to illuminate the interior of cab 100 in the event of the detection of loss of power to the cab. Further, activation of auxiliary light fixture 102 is not dependent on detection of the loss of power to either cab 100 or primary light source 108.

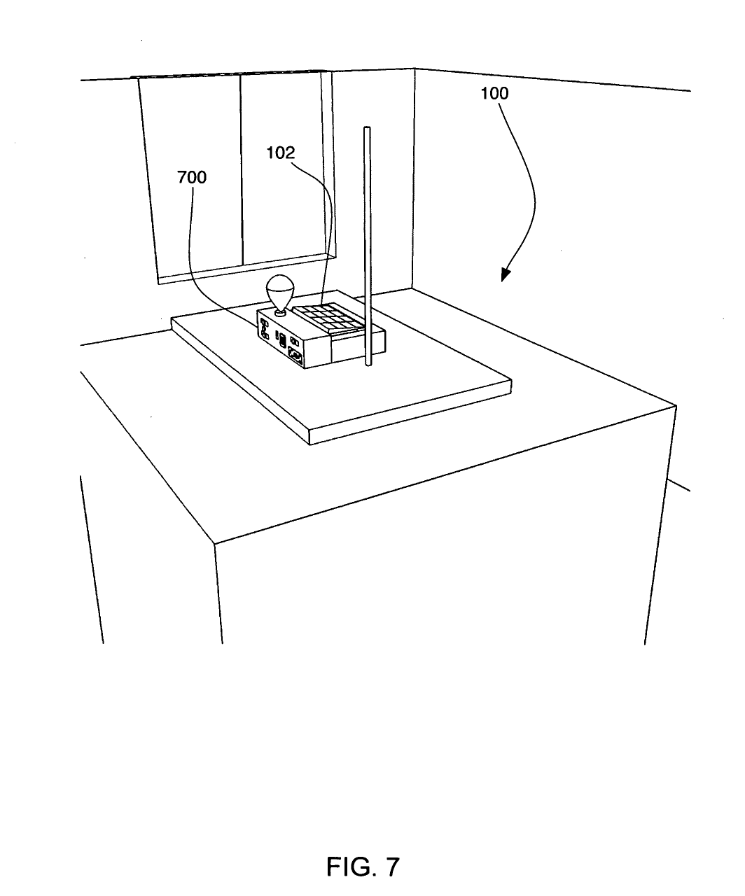

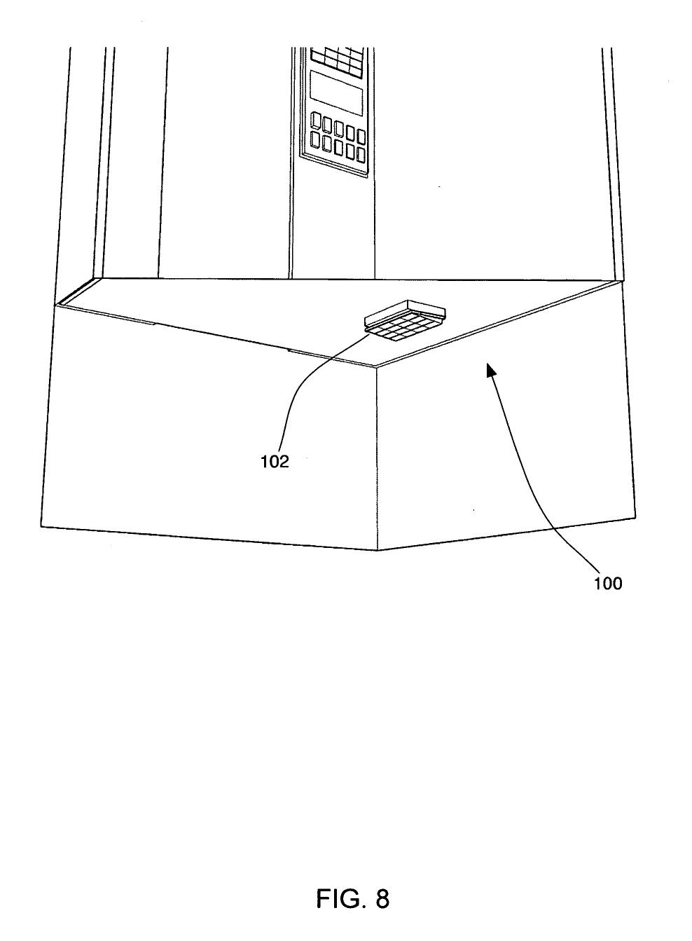

In an alternate embodiment described in detail in connection with FIGS. 7 and 8, an auxiliary light fixture 102 is positioned on the exterior of cab 100 to provide illumination to workers working on the outside of the cab in response to detection of loss of light of a primary light source outside the cab. In a specific embodiment, light fixture 102 is mounted on the roof of cab 100 to provide auxiliary or emergency illumination for workers on top of the cab in the event of a failure of a primary lighting source 700, e.g., a car-top inspection station light, for the worker. According to this embodiment, the auxiliary fixture is enabled through a car top inspection station during the presence of workers on top of cab 100. In the event of a failure of a primary light source under cab 100, in another specific embodiment illustrated in FIG. 8, an auxiliary light fixture is mounted on the underside of cab 100 to provide illumination beneath the cab for workers working below the cab.

FIG. 3 is a block diagram of an embodiment of auxiliary light fixture 102 similar to the above-described FIG. 2 embodiment and includes a charging unit 300 connected between energy storage unit 204 and power source 208. Charging unit 300 monitors the amount of energy stored in energy storage unit 204 and provides current from power source 208 to charge the energy storage unit in response to the voltage of unit 204 dropping below a desired value.

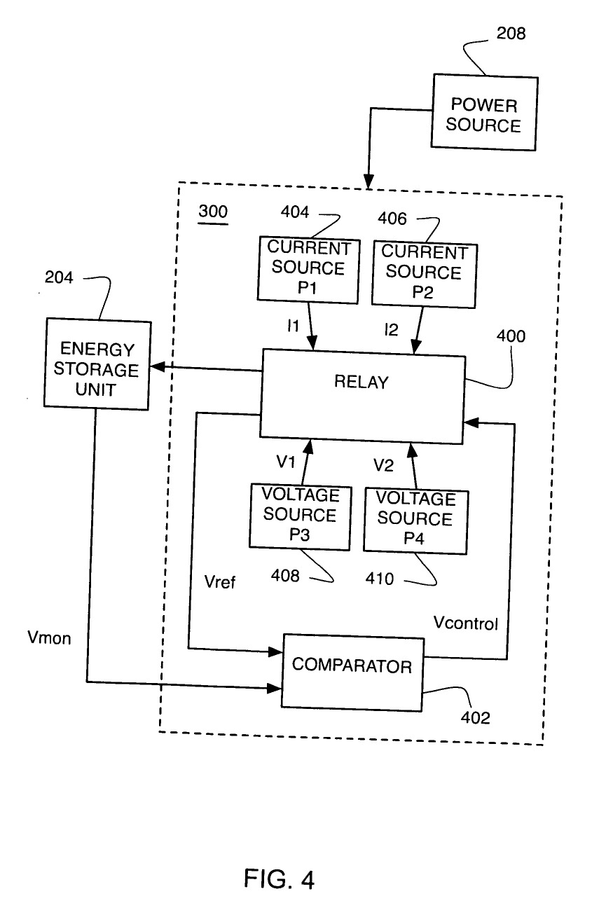

As described below in conjunction with FIG. 4, charging unit 300 is configured to charge energy storage unit 204 and maintain the voltage level of the energy storage unit at an optimum level such that the voltage level of the storage unit is maintained at a desired value while charging unit 300 is responsive to current from power source 208. In other embodiments, charging unit 300 is a charging unit capable of supplying current to energy storage unit 204 until a preset voltage level is reached whereupon the current supplied is cutoff.

FIG. 4 is a detailed block diagram of charging unit 300 (FIG. 3). Charging unit 300 connects power source 208 to energy storage unit 204 and includes a double-pole, double-throw relay 400 connected with power source 208, energy storage unit 204, and voltage comparator 402. Double-pole, double-throw relay 400 responds to a single input from voltage comparator 402 by selectively switching from inputs from sources 404, 406, 408, and 410 to two separate outputs. Sources 404 and 406 are DC current sources that include rectifiers (not shown) powered by AC current from power source 208, so that sources 404 and 406 respectively supply predetermined currents I1 and I2 to a first pair of inputs of relay 400 where I2 exceeds I1. Sources 408 and 410 are DC voltage sources including rectifiers (not shown) powered by AC voltage from power source 208 so that sources 408 and 410 supply predetermined DC voltages V1 and V2 to a second pair of inputs to relay 400, where V2 exceeds V1. In other words, the output of comparator 402 controls both outputs of relay 400.

Relay 400 receives four different inputs P1-P4 having different voltage and current values along with a control input Vcontrol from comparator 402. Relay 400 provides a particular DC current level I1 and I2 from either source 404 or source 406 to energy storage unit 204 in response to the value of a bilevel signal received from comparator 402. At the same time and in response to the input signal from comparator 402, relay 400 provides a DC voltage level V1 or V2 from one of source 408 or source 410 to an input Vref of comparator 402.

Comparator 402 responds to its input Vref from relay 400 as described above, and DC input voltage, Vmon, from energy storage unit 204 indicating the DC voltage level of energy storage unit 204. Comparator 402 compares the input voltage levels Vref and Vmon to derive the bilevel output Vcontrol that the comparator supplies to relay 400 as described above. If the Vref voltage level from relay 400 exceeds the Vmon voltage level from energy storage unit 204, comparator 402 provides a first Vcontrol signal amplitude to relay 400 and if the Vmon voltage level received from relay 400 exceeds the Vref voltage level received from the energy storage unit, comparator 402 provides a second Vcontrol signal amplitude to the relay.

In accordance with a particular embodiment, energy storage unit 204 is a nickel metal hydride 6.2 volt battery and source 404 provides a DC current level of 12 milliamperes (mA). Source 406 provides a DC current level of 400 mA, source 408 provides a DC reference voltage level of 5.3 volts, and source 410 provides a DC reference voltage level of 5.85 volts. With respect to the particular embodiment described, the inventor has found that 12 mA charging current to the battery of energy storage unit 204 is sufficient to prevent leakage discharge of the battery while at the same time being insufficient to cause excessive charging of the battery. In this manner, the battery is not continually charged and discharged, rather the battery charge is maintained without discharge.

Operation of charging circuit 300 is now described assuming energy storage unit 204 initially has a discharged voltage level, e.g., a voltage level lower than Vref, and relay 400 is in an energized state to provide the current level of 12 mA from source 404 to the energy storage unit and the voltage level of 5.3 volts from source 408 to comparator 402. Comparator 402 compares the discharged voltage level Vmon from energy storage unit 204 with the 5.3 voltage level Vref from relay 400. Because Vref exceeds Vmon, comparator 402 derives the second Vcontrol amplitude which causes relay 400 to be activated to a first state so that sources 406 and 410 are respectively coupled to the outputs of relay 400 which are connected to the input of energy storage unit 204 and Vref input of comparator 402. Relay 400 entering a non-energized state switches from source 404 to source 406 provided as output to energy storage unit 204 and from source 408 to source 410 as an input to comparator 402. At this point, energy storage unit 204 is being charged at a current level of 400 mA provided from source 406 and comparator 402 compares the voltage, Vmon, from the energy storage unit to a 5.85 voltage level Vref from source 410.

In response to energy storage unit 204 reaching a voltage level exceeding 5.85 volts, comparator 402 determines that the energy storage unit output voltage, Vmon, equals or exceeds voltage level input Vref (currently at 5.85 volts) and provides the first Vcontrol amplitude to relay 400 to activate the relay to a second state. In the second state, relay 400 switches to provide the current level of 12 mA from source 404 to energy storage unit 204 and the voltage level of 5.3 volts from source 408 to comparator 402. At this point, relay 400 is providing a minimal trickle current level (12 mA) to energy storage unit 204 thereby preventing discharge of the battery of the storage unit.

During use, energy storage unit 204 discharges stored energy to light source 200 as described in conjunction with FIG. 3. In response to energy storage unit 204 reaching a stored voltage level below 5.3 volts, relay 400 is reactivated to the first state, causing source 406 to supply 400 mA charging current to unit 204 as previously described.

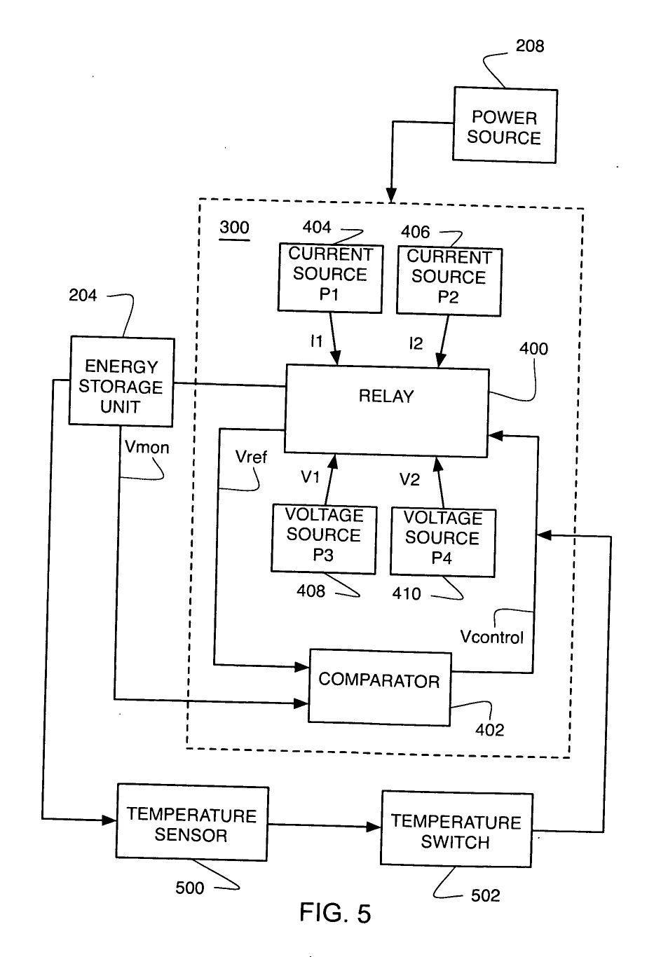

In another embodiment illustrated in FIG. 5, charging unit 300 connects energy storage unit 204 with power source 208 as described above in conjunction with FIG. 4. The FIG. 5 embodiment differs from the FIG. 4 embodiment by mounting temperature sensor 500 on energy storage unit 204, to thereby provide a bilevel signal indicative of the temperature of unit 204 being above or below a predetermined temperature value. Sensor 500 is connected to temperature switch 502 which supplies an input signal to relay 400. Sensor 500 and switch 502 can be a temperature-responsive, bilevel contact that is closed to connect a DC voltage having a third value that differs substantially from the bilevel Vcontrol output voltage of a comparator 402. In response to the third voltage level being applied to relay 400, the contacts of the relay connected to current sources 404 and 406 are open-circuited so no charging current is supplied to the battery of energy storage unit 204. As a result, the battery of unit 204 can cool to prevent overheating and/or combustion in response to the temperature of unit 204 exceeding the predetermined temperature value. Hence, to minimize or prevent damage from an overheated energy storage unit 204, temperature switch 502 operates in response to the temperature signal from temperature sensor 500 indicating the temperature adjacent the energy storage unit exceeds the predetermined value, to cause relay 400 to stop providing current to the energy storage unit. Temperature sensor 500 thus compares the temperature of a battery being charged by relay 400 with the predetermined temperature value to prevent overheating and possibly combustion of the battery.

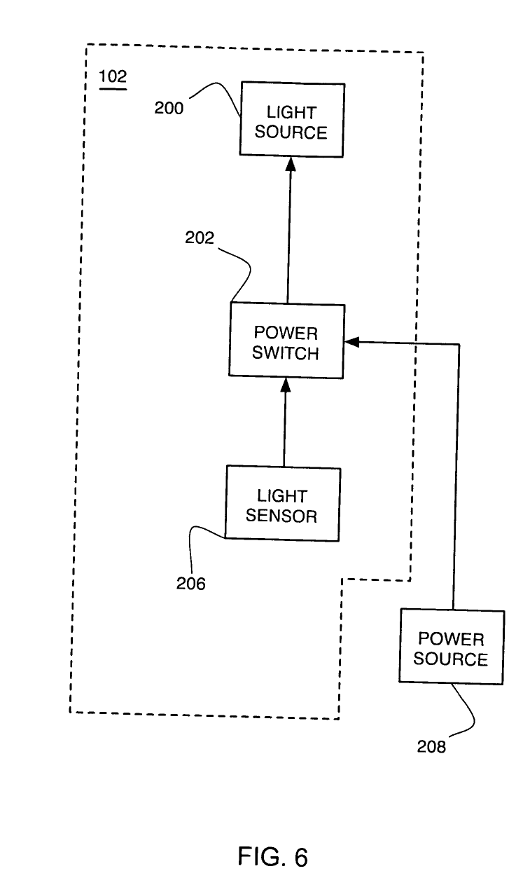

In an embodiment depicted in FIG. 6, fixture 102 includes power switch 202 connected to auxiliary light source 200, light sensor 206, and power source 208. Power switch controls the flow of current to light source 200 as described above with reference to FIG. 2; however, the fixture 102 of FIG. 6 differs from the fixture of FIG. 2 by not including energy storage unit 204 (FIG. 2). In this manner, auxiliary light source 200 receives current from power source 208 in response to primary light source 108 becoming disabled.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is, therefore, intended that the protection granted hereon be limited only by the definition contained in the appended claims and equivalents thereof.

1. An auxiliary illumination arrangement for an elevator cab comprising:
an auxiliary light source adapted to be attached to an elevator cab having a primary illumination source;
a light sensor arranged to transmit a light loss signal in response to detection of light from the primary illumination source being below a predetermined light threshold; and
a power switch operatively connectable with a power source and the auxiliary light source for coupling power from the power source to the auxiliary light source in response to receipt of the light loss signal.

2. An arrangement as in claim 1, wherein the power source includes an energy storage unit operatively connectable with the power switch.

3. An arrangement as in claim 2, wherein the power switch is arranged to enable the energy storage unit to power the auxiliary light source in response to loss of power from the power source.

4. An arrangement as in claim 1, wherein the light source comprises one or more light emitting solid state devices.

5. An arrangement as in claim 1, wherein the light source is mounted interior to the elevator cab.

6. An arrangement as in claim 1, wherein the light source is mounted exterior to the elevator cab.

7. An arrangement as in claim 2, further comprising:
a charging unit operatively connectable between the energy storage unit and the power source and arranged to control charging of the energy storage unit by the power source.

8. An arrangement as in claim 7, wherein the charging circuit comprises:
a relay configured to control current flow to the energy storage unit; and
a comparator configured to control the relay in response to output voltage of the energy storage unit.

9. An arrangement as in claim 8, wherein the comparator is configured to control the relay based on a comparison of a voltage level of the energy storage unit with a reference voltage level from the relay.

10. An arrangement as in claim 9, wherein the relay is configured to selectively supply to the energy storage unit a low current and a high current in response to the control from the comparator.

11. An arrangement as in claim 10, wherein the comparator is configured to cause the relay to be in: (1) a low charging current state in response to the voltage level of the energy storage unit exceeding the voltage level from the relay and (2) a high charging current state in response to the voltage level from the relay exceeding the voltage level of the energy storage unit.

12. An arrangement as in claim 10, wherein the relay is configured to provide a low voltage level to the comparator for comparison with the voltage level of the energy storage unit in response to the relay being in a low charging current state and to provide a high voltage level to the comparator for comparison with the voltage level of the energy storage unit in response to the relay being in a high charging current state.

13. An arrangement as in claim 7, further comprising:
a temperature sensor positioned to be responsive to the temperature of the energy storage unit; and
a temperature switch connected with the temperature sensor and the charging circuit and configured to control the charging circuit responsive to the temperature sensor.

14. An arrangement as in claim 13, wherein the temperature switch is configured to control the charging circuit if the temperature sensed by the temperature sensor exceeds a predetermined temperature threshold.

15. An elevator cab, comprising:
a primary light source connected to a first power supply; and
the auxiliary elevator illumination arrangement of claim 1.

16. An elevator cab as in claim 15, wherein the light sensor is arranged to detect a light level within the elevator cab.

17. An elevator cab as in claim 15, wherein the light sensor is arranged to detect a light level in an area external to the elevator cab and within the elevator shaft.

18. A method of illuminating an elevator cab, comprising:
monitoring a light level provided by a primary light source connected to the elevator cab; and
activating an auxiliary elevator light connected to the elevator cab in response to detection of the light level from the primary light source falling below a predetermined threshold.

19. A method as in claim 18, wherein the monitoring step includes monitoring the light level in an interior of the elevator cab and the activating step includes activating the auxiliary elevator light to provide light to the interior of the elevator cab.

20. A method as in claim 18, wherein the monitoring step includes monitoring the light level exterior to the elevator cab and the activating step includes activating the auxiliary elevator light to provide light to the exterior of the elevator cab.

21. An illumination arrangement for an elevator cab comprising:
a light source adapted to be attached to an elevator cab, wherein the light source comprises one or more light emitting solid state devices.

22. An arrangement as in claim 21, wherein the light source is mounted interior to the elevator cab.

23. An arrangement as in claim 21, wherein the light source is mounted exterior to the elevator cab.

24. An elevator cab, comprising:
an elevator illumination arrangement of claim 21.
